(19) United States
(12) Patent Application Publication
(10) Pub. No.: US 2012/0034890 A1
(43) Pub. Date: Feb. 9, 2012

(54) GEOGRAPHICALLY RELATED RADIO RECEPTION AND STATION SELECTION DEVICE AND METHOD

(76) Inventor: Xiaoming CHEN, Zhejiang (CN)

(21) Appl. No.: 13/012,734

(22) Filed: Jan. 24, 2011

(30) Foreign Application Priority Data
May 14, 2010 (CN) 201010175194.0

(51) Int. Cl. H04B 1/18

(52) U.S. Cl. 455/150.1

(57) ABSTRACT

This invention relates a radio reception and station selection device related to geographical regions. It includes a tuning module and an AF output module, the tuning module interconnects the AF output module, the device further includes a positioning module, a display input module and a control module, each of the positioning module, the display input module and the tuning module connects the control module. This invention also provides a geographically related radio reception and station selection method. The device can display the station name, frequency, mode, and signal strength level of the local station signal source receivable on the display input module according to the Radio Regulations, and dynamically refresh with geographical changes. By using this device, listeners no longer need search for stations and store their names by themselves, it is a very convenient, time-saving device with an excellent visual operating system.

### CROSS REFERENCE TO RELATED APPLICATION

This patent application claims priority to Chinese Patent Application No. 201010175194.0, filed on May 14, 2010, which is hereby incorporated by reference in its entirety.

### FIELD OF THE INVENTION

This invention relates to the field of broadcasting, in particular, it relates to a geographical related radio reception and station selection device and method mainly used in radios or mobile phones.

### BACKGROUND OF THE INVENTION

In the prior radio reception and station selection device, it requires us to adjust the receiving frequency of the device and then choose the program one are intended to listen, therefore, an automatic station searching and channel storage method is then invented with the purpose to reduce the station selection time. However, this method requires the listener himself to establish a mapping (i.e. corresponding relationship) relation between the name of the station and the number of pre-stored channels based on memory or records. Since the electric wave of every broadcast program source needs to meet the requirements of Radio Regulations, the listener has to re-adjust the receiving frequency and search the station again when he arrives (especially in fast movement) in a new area, where the pre-stored channels will be changed or dynamically refreshed accordingly. This indirectly method is time-consuming and highly inconvenient.

### SUMMARY OF THE INVENTION

The technical problem of this invention to be solved is to conquer existing technical defects and provide a direct, efficient, and extremely convenient radio reception and station selection device related to geographical regions.

The technical solution of this invention is to provide a geographically related radio reception and station selection device, it includes a tuning module and an AF output module, the tuning module interconnects the AF output module, the device further includes a positioning module, a display input module and a control module, each of the positioning module, the display input module and the tuning module connects the control module.

As an improvement, the tuning module includes at least one tuner, the tuner connects the control module. When using multiple tuners, one tuner will be used to select the program one are listening and the other will be used to instantly refresh the program catalogues in background along with geographical changes.

The further purpose of this invention is to provide a new radio reception and station selection method, comprises:

Step 1: The device functions on the basis of the station information including the name, frequency, and mode of the station in different geographically pre-stored areas in accordance with regional Radio Regulations;

Step 2: Positioning module of the device is used not only to provide geographical location information but choose a station signal group under local Radio Regulations according to the geographical location information and stored station information of various regions;

Step 3: The control module will drive the tuning module to take turns to examine the radio signal strength of above radio signal group and display the station name, frequency, mode, strength level of such station signal on the display input module when the signal strength reaches its best receiving threshold, or otherwise they will not be displayed and all information (e.g. Name, frequency, mode, signal strength of the station) that meet the receiving requirements of the current region will be displayed on display input module; and

Step 4: Listeners can choose different stations straightaway based on the station information stored in display input module, and then the device will adjust the tuning module to its corresponding frequency to listen according to the station selection orders.

The geographical location information stated in the step 2 is the geographical region name under Radio Regulations determined by its latitude and longitude or decoded by IP address, postcode, or telephone area code.

By using above methods, the device has the capability to display the name, frequency, mode, strength level of the station of the receivable signal source on the display input module according to the Radio Regulations and to change or refresh dynamically with geographical changes. The listener can select his intended stations according to the display (e.g. Name, frequency, mode, signal strength of the station that meet the receiving requirements) of the display input module without searching the stations himself and storing the name of each station. It is a direct, efficient, and extremely convenient solution.

### BRIEF DESCRIPTION OF THE DRAWINGS

FIG. 1 shows a block diagram of the geographically related radio reception and station selection device and method of this invention; and

FIG. 2 shows a flow diagram of the geographically related radio reception and station selection device and method of this invention.

### DETAILED DESCRIPTION OF THE PREFERRED EMBODIMENT

These and other features of this invention will be further apparent from the ensuing description, drawings, and appended claims.

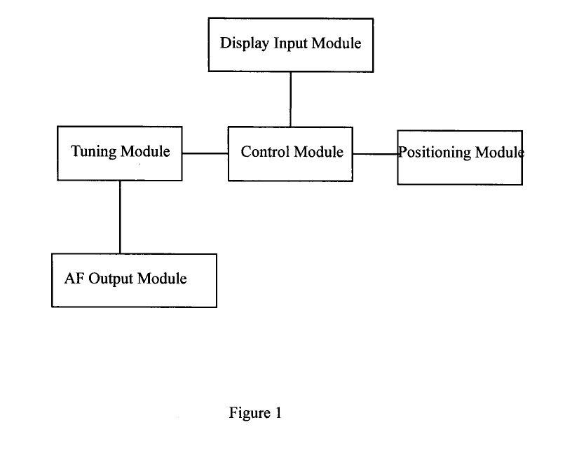

As shown in FIG. 1, this invention is a fast radio reception and station selection device under movement, it includes a tuning module and an AF output module, the tuning module interconnects the AF output module, the device further includes a positioning module, a display input module and a control module, each of the positioning module, the display input module and the tuning module connects the control module.

The positioning module is a device used to obtain the current geographical location information. In this embodiment, one use a GPS positioning chip, from which the positioning module obtains latitude and longitude information and decodes them as the geographical region name that is in conformity with Radio Regulations. The tuning module of this invention is a digital tuner commonly encountered in normal radio reception and station selection devices. In this embodiment, the display input module uses touch screen that can be used both for display and input. The control module uses a deal 6140 ARM module and the AF output module uses a common AF output module that includes an AF amplified circuit and a speaker.

As an improvement, the tuning module of this invention includes at least one tuner connecting the control module. In this embodiment, two tuners are used, one tuner is used to select the program one are listening to and the other is used to promptly refresh the local program catalogues in background along with geographical changes.

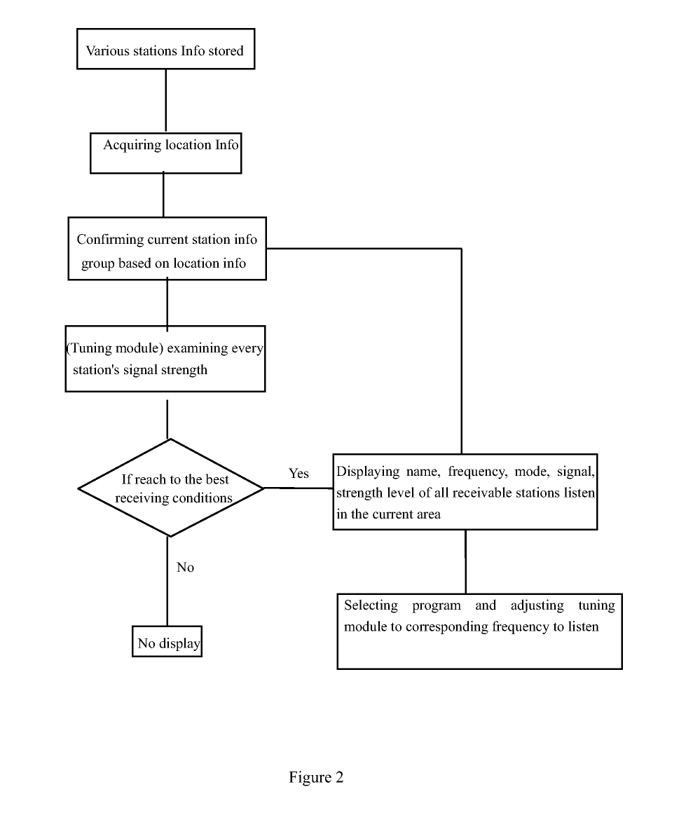

As shown in FIG. 2, this invention also provides a method for radio reception and station selection related to geographical regions, comprises:

Step 1: The device functions on the basis of the station information including the name, frequency, and mode of the station in different geographically pre-stored areas in accordance with regional Radio Regulations;

The device stores regional station information in the control module, that is, the name, frequency, and mode of the station in the Radio Regulations with respect to geographical locations. The control module is to divide above information according to different regions and store them in the form of tables.

Step 2: Positioning module of the device is used not only to provide geographical location information but choose a station signal group under local Radio Regulations according to the geographical location information and stored station information of various regions.

The current geographical location information provided by the positioning module of the device can be circularly read out from the positioning module through the control module. Active transmission method from the positioning module to the control module can also be employed every time when the location changes.

The connection between the positioning module and the control module ensures when location changes to the device the current geographical location information can be transmitted to the control module, which will choose current station signal group according to the present geographical location information.

Step 3: The control module will drive the tuning module to take turns to examine the radio signal strength of above radio signal group and display the station name, frequency, mode, strength level of such station signal on the display input module when the signal strength reaches its best receiving threshold, or otherwise they will not be displayed and all information (e.g. Name, frequency, mode, signal strength of the station) that meet the receiving requirements of the current region will be displayed on display input module.

Examination involves all station signals in conformity with the Radio Regulations.

Step 4: Listeners can choose different stations straightaway based on the station information stored in display input module, and then the device will adjust the tuning module to its corresponding frequency to listen according to the station selection orders.

Listeners can directly select the station by operating on the touch screen or keyboard input. Once the station is selected, the control module can adjust the tuning module to the corresponding frequency according to the station selection orders and output sound through AF output module.

We claim:

1. A radio reception and station selection device related to geographical regions, including a tuning module and an AF output module, the tuning module interconnecting the AF output module, wherein the device further including a positioning module, a display input module and a control module, each of the positioning module, the display input module and the tuning module connecting the control module.

2. The radio reception and station selection device related to geographical regions according to claim 1, wherein the tuning module including at least one tuner, the tuner connecting the control module.

3. A geographically related radio reception and station selection method, comprising:
Step 1: The radio reception and station selection device functions on the basis of the station information including the name, frequency, and mode of the station in different geographically pre-stored areas in accordance with regional Radio Regulations;
Step 2: Positioning module of the device is used not only to provide geographical location information but choose a station signal group under local Radio Regulations according to the geographical location information and stored station information of various regions;
Step 3: The control module will drive the tuning module to take turns to examine the radio signal strength of above radio signal group and display the name, frequency, mode, strength level of the station on the display input module when the signal strength reaches its best receiving threshold, or otherwise they will not be displayed and all information, e.g. Name, frequency, mode, signal strength of the station, that meet the receiving requirements of the current region will be displayed on display input module; and
Step 4: Listeners can choose different stations straightaway based on the station information stored in display input module, and then the device will adjust the tuning module to its corresponding frequency to listen according to the station selection orders.

4. The method according to claim 3, wherein the geographical location information stated in the step 2 is the geographical region name under Radio Regulations determined by its latitude and longitude or decoded by its IP address, postcode, or telephone area code.

5. The method according to claim 3, wherein the current geographical location information provided by the positioning module of the device stated in the step 2 is circularly read out from the positioning module through the control module.

6. The method according to claim 3, wherein the current geographical location information provided the positioning module adopts a method that when location changes the positioning module will actively transmit the geographical location information to the control module.
